(19) United States
(12) Patent Application Publication
(10) Pub. No.: US 2018/0077571 A1
(43) Pub. Date: Mar. 15, 2018

(54) SYSTEM AND METHOD OF AUTHENTICATING A USER OF AN ELECTRONIC DEVICE

(71) Applicant: Wipro Limited, Bangalore (IN)

(72) Inventors: Raghottam MANNOPANTAR, Bangalore (IN); Raghavendra Hosabettu, Bangalore (IN)

(73) Assignee: Wipro Limited

(21) Appl. No.: 15/358,279

(22) Filed: Nov. 22, 2016

(30) Foreign Application Priority Data
Sep. 13, 2016 (IN) 201641031220

(51) Int. Cl. H04W 12/06; H04L 29/06

(52) U.S. Cl. CPC H04W 12/06; G06F 3/04886; H04L 63/083

(57) ABSTRACT

In certain embodiments, a method of authenticating a user on an electronic device is disclosed. The method includes accessing, by an authentication device, a primary Personal Identification Number (PIN) associated with the user. The primary PIN may include one or more alpha-numeric characters. Thereafter, a plurality of primary alpha-numeric characters associated with a plurality of secondary alpha-numeric characters may be displayed. Each secondary alpha-numeric character may be associated with a color and the primary alpha-numeric characters may include the plurality of characters associated with the primary PIN. Subsequently, the authentication device may receive a dynamic PIN from the user. The dynamic PIN may include a combination of one or more secondary alpha-numeric characters and one or more colors. On receiving the dynamic PIN, the user may be authenticated by comparing the dynamic PIN with one or more secondary alpha-numeric characters and one or more colors associated with the primary PIN.

### TECHNICAL FIELD

The present disclosure relates generally to user authentication. More specifically, it relates to a system and method for authenticating a user on an electronic device using a dynamically created Personal Identification Number (PIN).

### BACKGROUND

A plethora of smart devices store private user information that need to be protected from shoulder browsing or hacking. This may be achieved by securing information such as a Personal Identification Number (PIN). The mechanism to protect the data is to lock when not in use and to have a secure PIN or pattern to unlock the phone.

The password or PIN or pattern can be understood by an unauthorized third person observing the movements of the finger on the touch pad/key pad during the entry of such information. This is also known as shoulder browsing. A user entering a PIN or a password on an electronic device needs to safeguard against shoulder browsing to prevent other parties in the vicinity from learning the user's PIN.

There are PIN (numerical PIN) entry systems which accept alpha-numeric data. There are pattern entry systems which accept non-alphanumeric data. The disadvantage of these systems is that the malicious monitoring software can easily capture any key entered by a user into his/her PC/smart phones.

### SUMMARY

In certain embodiments, a method of authenticating a user on an electronic device is disclosed. The method includes accessing, by an authentication device, a primary Personal Identification Number (PIN) associated with the user. The primary PIN may include one or more alpha-numeric characters. Thereafter, a plurality of primary alpha-numeric characters associated with a plurality of secondary alpha-numeric characters may be displayed. Each secondary alpha-numeric character may be associated with a color and the primary alpha-numeric characters may include the plurality of characters associated with the primary PIN. Subsequently, the authentication device may receive a dynamic PIN from the user. The dynamic PIN may include a combination of one or more secondary alpha-numeric characters and one or more colors. On receiving the dynamic PIN, the user may be authenticated by comparing the dynamic PIN with one or more secondary alpha-numeric characters and one or more colors associated with the primary PIN.

Certain embodiments of the present disclosure may also relate to an authentication device for authenticating a user on an electronic device. The authentication device may include a processor and a memory storing instructions that, when executed by the processor, causes the processor to: access a primary Personal Identification Number (PIN) associated with the user, wherein the primary PIN comprises at least one alpha-numeric character. The memory may further store instructions to display a plurality of primary alpha-numeric characters associated with a plurality of secondary alpha-numeric characters. Each secondary alpha-numeric character may be associated with a color and the primary alpha-numeric characters may include the plurality of characters associated with the primary PIN. Further, the memory may include instructions to receive a dynamic PIN from the user. The dynamic PIN may include a combination of one or more secondary alpha-numeric characters and one or more colors. The memory may also include instructions to authenticate the user by comparing the dynamic PIN with one or more secondary alpha-numeric characters and one or more colors associated with the primary PIN.

In another embodiment, a non-transitory computer-readable storage medium for authenticating a user on an electronic device is disclosed, which when executed by a computing device, cause the computing device to perform operations including accessing, by an authentication device, a primary Personal Identification Number (PIN) associated with the user. The primary PIN may include one or more alpha-numeric characters. Thereafter, a plurality of primary alpha-numeric characters associated with a plurality of secondary alpha-numeric characters may be displayed. Each secondary alpha-numeric character may be associated with a color and the primary alpha-numeric characters may include the plurality of characters associated with the primary PIN. Subsequently, the operations include receiving a dynamic PIN from the user. The dynamic PIN may include a combination of one or more secondary alpha-numeric characters and one or more colors. On receiving the dynamic PIN, the user may be authenticated by comparing the dynamic PIN with one or more secondary alpha-numeric characters and one or more colors associated with the primary PIN.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 illustrates an exemplary overview of a system for authenticating a user on an electronic device, according to some embodiments of the present disclosure.

FIG. 2 is a flowchart of an exemplary method for authenticating a user on an electronic device, according to some embodiments of the present disclosure.

FIG. 3 is another flowchart of an exemplary method for authenticating a user on an electronic device, according to some embodiments of the present disclosure

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

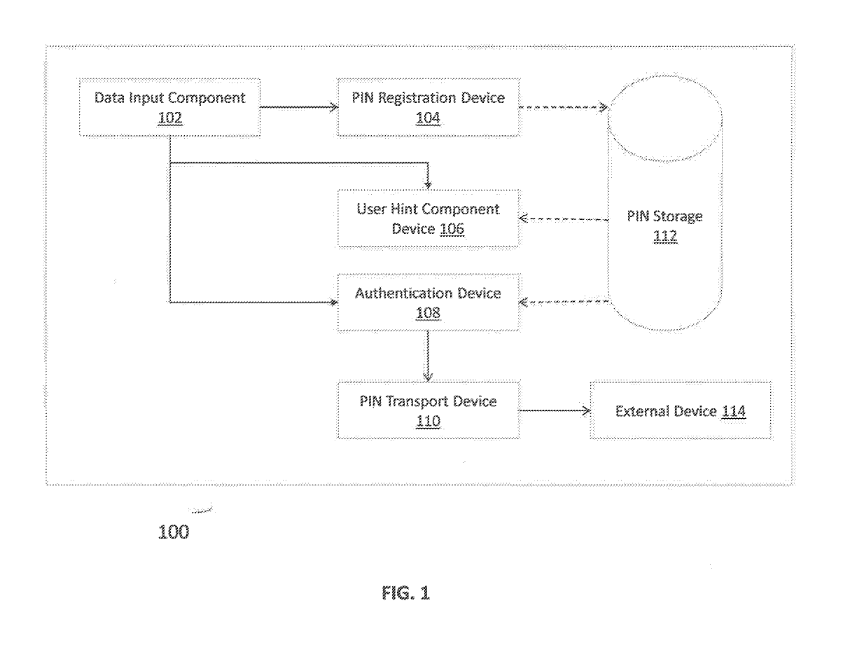

FIG. 1 illustrates an exemplary overview of a system for authenticating a user on an electronic device in accordance with some embodiments of the present disclosure.

The system 100 includes a data input component 102 which is in electronic communication with a primary Personal Identification Number (PIN) registration device 104, a user hint component device 106, an authentication device 108, and a PIN transport device 110. The primary PIN registration device 104 is further in electronic communication with the PIN storage database 112. The PIN storage database 112 is also in electronic communication with the user hint component device 106 and the PIN authentication device 108. The authentication device 108 is connected to a PIN transport device 110. The PIN transport device 110 is further connected to an external device 114.

The system 100 may be an application that is installed in any smart device, for example a smartphone. The system 100 works towards securing the smartphone device information by providing an interface to lock and unlock the screen. The technical mechanism to unlock the smartphone is achieved by the working capabilities and collaboration of the components of the system 100. The user may register a primary PIN via the PIN registration device 104. The primary PIN may correspond to a predefined sequence of alpha-numeric characters that the user may have selected to be the PIN for a particular application. In some embodiments, the user may define a PIN and then register the PIN. In other embodiments, the PIN may be provided to the user by a third party service provider. The primary PIN provided by the user of the smartphone may be validated by the PIN registration device 104 and if the primary PIN is valid, the primary PIN may be registered in a database such as the PIN storage database 112. If the primary PIN is not valid, the user may be asked to re-enter the primary PIN. In some embodiments, a virtual keypad may be provided to the user in order to register the PIN with system 100.

The authentication device 108 may access the primary PIN registered by the user from the PIN storage database 112. Based on the primary PIN provided by the user, the authentication device 108 may generate and display a plurality of primary alpha-numeric characters (hereinafter referred to as “primary characters”) to the user. The primary characters may include the characters associated with the primary PIN. For example, if the primary PIN is “7489”, the primary characters displayed may include the numbers ‘7’, ‘4’, ‘8’ and ‘9’. However, it is to be noted that in addition to the characters that make up the primary PIN, the primary characters may include other alpha-numeric characters also.

Further, the primary characters may be associated with a plurality of secondary alpha-numeric characters (hereinafter referred as “secondary characters”). Each primary character may be associated with a secondary character. The mapping between the primary and secondary characters is exemplarily illustrated in the Table 1.

TABLE 1

| | | | | | | | | | |
|---|---|---|---|---|---|---|---|---|---|
| 1 | 2 | 3 | 4 | 5 | 6 | 7 | 8 | 9 | 0 |
| 7 | 2 | 3 | 6 | 8 | 9 | 5 | 0 | 4 | 1 |

Here, the first row represents the primary characters and the second row represents the secondary characters. As can be seen from Table 1, the primary character ‘1’ is mapped to the secondary character ‘7’, the primary character ‘2’ is mapped to the secondary character ‘2’ and so on.

Further, each of the secondary characters may be associated with a color. For example, the secondary character ‘9’ associated with the primary character ‘6’ may be associated with the color red. In some embodiments, the color red may fill the background associated with the secondary character ‘9’. In some other embodiments, the font color associated with the secondary character ‘9’ may be red. Similarly, each of the secondary characters may be associated with a color. The color associated with each of the secondary characters may be changed periodically. In keeping with the previous example, the secondary character ‘9’ may be associated with a color ‘blue’ after a predefined time. The plurality of primary characters and the plurality of secondary characters associated with colors may form a hint User Interface (UI). It will be apparent to a person skilled in the art that any number of colors may be associated with the secondary characters without deviating from the scope of the present disclosure.

Once the hint UI is displayed to the user, the user may be prompted to enter a dynamic PIN. To enter the dynamic PIN, the user may look-up the characters associated with the primary PIN to identify the corresponding secondary characters and a color associated with the secondary character. For example, if the primary PIN of the user is “7-4-6-0”, then the user may first identify the secondary character mapped to the primary character ‘7’. From Table 1, the user may identify the secondary character associated with primary character ‘7’ as ‘5’. Further, the user may identify the color associated with the secondary character ‘5’. If, for example, the color associated with ‘5’ is red, then the user may input ‘5’ along with the color red. In order to do this, the user may be provided with an alpha-numeric keypad. Each character of the keypad may be associated with a color. The color associated with each character may change periodically, typically after every few seconds. The user may select the number ‘5’ when the associated color on the keypad is red and provide this as input. This may be done for each character of the primary PIN.

The authentication device 108 may receive the dynamic PIN from the user and authenticate the dynamic PIN by comparing the dynamic PIN with the secondary character and color combination associated with the primary PIN. Here, each character of the primary PIN may be looked up in Table 1 to identify the secondary character and color combination for that point in time. If the user is authenticated, then the electronic device is unlocked otherwise remains locked. If the dynamic PIN entered is correct but color combination is not matching, an alert message may be sent to the user. The alert message may be sent on an alternate device of the user in order to notify the user that the user's smartphone has been tried to be unlocked.

The PIN transport device 110 is an optional component which can be added with the data input component device 102 and the authentication device 108. The PIN transport device 110 transfers the authentication result or the dynamic PIN itself to the external device 114 which is connected to the authentication device 108 which has the proposed solution. Further, the external device 114 handles the dynamic PIN and/or the result received to unlock.

Thus, one of the advantages of the disclosed system disclosed is that the user has to remember only one PIN based on which the dynamic PIN is generated which the user can input by observing the hint UI. This is because the dynamic PIN entered by a user is different every time and the user can input the alpha-numeric secondary PIN characters along with its dynamically generated associated color in any sequence.

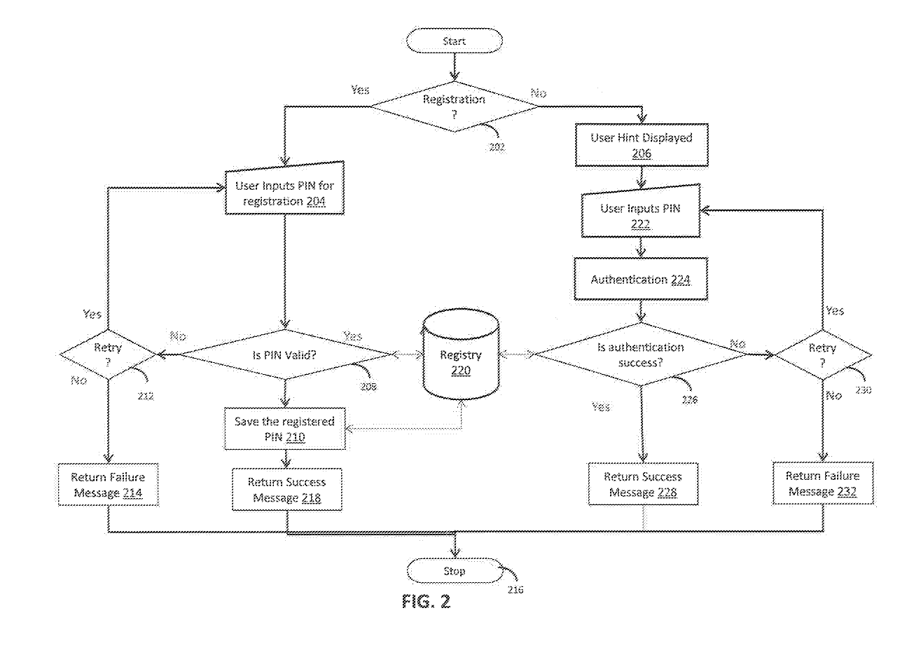

FIG. 2 is a flowchart of an exemplary method of authenticating a user of an electronic device in accordance with some embodiments of the present disclosure.

At step 202, the user may be prompted to register a primary PIN with the authentication device 108 (not shown in FIG. 2).

If the primary PIN is not already registered by the electronic device then, at step 204, the user may input the primary PIN for registration. However, if the primary PIN is already registered, the hint UI may be displayed to the user in the electronic device at step 206. Displaying the hint UI to the user is explained in detail in conjunction with FIG. 1.

Thereafter, at step 208, a check is performed if the primary PIN entered by the user is valid. If the primary PIN is valid, then the registered primary PIN may be saved. If the primary PIN is not valid, the process terminates at step 216.

At step 220, the validated primary PIN is stored in a registry.

At step 222, the user inputs the dynamic PIN on the hint UI. The dynamic PIN corresponds to a combination of one or more alpha-numeric characters and colors corresponding to the primary characters of the primary PIN. The hint UI is explained in detail in conjunction with FIG. 1.

At step 224, the dynamic PIN (alpha-numeric digit and color) entered is authenticated. At step 226, a check is performed to determine if the authentication is a success, if not, the user may be prompted to retry inputting the PIN at step 230. At step 228, a success message may be returned to the user if the authentication is successful. At step 232, a failure message or a failure notification is returned to the user after the user exceeds the threshold limit of dynamic PIN re-entry and the process is terminated.

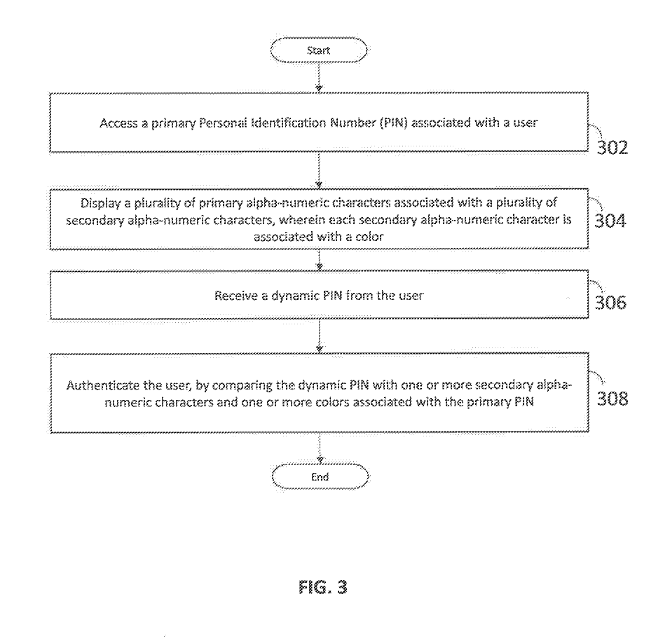

FIG. 3 is another flowchart of an exemplary method of authenticating a user on an electronic device in accordance with some embodiments of the present disclosure.

At step 302, a primary Personal Identification Number (PIN) associated with the user may be accessed. Based on the primary PIN provided by the user, a plurality of primary alpha-numeric characters (hereinafter referred to as “primary characters”) may be displayed to the user at step 304. The primary characters may include the characters associated with the primary PIN. The primary characters may be associated with a plurality of secondary alpha-numeric characters (hereinafter referred as “secondary characters”) where each of the secondary characters is associated with a color as explained in conjunction with FIG. 1. The primary characters along with the associated secondary characters and the corresponding colors may be referred as a hint UI.

Once the hint UI is displayed to the user, the user may be prompted to enter a dynamic PIN. To enter the dynamic PIN, the user may look-up the characters associated with the primary PIN to identify the corresponding secondary characters and a color associated with the secondary character. The dynamic PIN entered by the user may be received at step 306. Thereafter, the user may be authenticated at step 308 by comparing the dynamic PIN with one or more secondary alpha-numeric characters and one or more colors associated with the primary PIN as explained in conjunction with FIG. 1.

Thus, the disclosure herein has the benefit that the user needs to remember only one PIN. There is no need to remember gesture, or any other values. Further, the user does not input the primary PIN and the dynamic PIN that the user enters changes with every transaction. As a result, in the event of shoulder browsing by a third party, no sensitive information may be viewed by the third party. The user can input secondary alpha-numeric characters and color of the dynamic PIN in any sequence. The PIN cannot be easily judged by the shoulder browser even though the browser can watch the hand movements on the key pad as the PIN is dynamic and changes after a predefined time interval. For example, the dynamic association of secondary alpha-numeric characters and colors may change if the user has not input the dynamic PIN for a certain period of time. The mechanism can also be used as secured PIN entry system for other devices with which the smart phone can interact. The smart phone is used for inputting the PIN and the result is passed to any external device. On receipt of the result device can unlock or lock for the user. There are other systems which also have the PIN entry system to unlock the system. These systems can be assisted with external device which accepts the PIN safely using the proposed solution. The authenticated PIN is passed to a main system and unlocking is done safely in the main system.

The specification has described systems and methods for authenticating a user on an electronic device. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method of authenticating a user on an electronic device,
the method comprising:
accessing, by an authentication device, a primary Personal Identification Number (PIN) associated with the user, wherein the primary PIN comprises at least one alpha-numeric character;
displaying, by the authentication device, a plurality of primary alpha-numeric characters associated with a plurality of secondary alpha-numeric characters, wherein each secondary alpha-numeric character is associated with a color, further wherein the plurality of primary alpha-numeric characters comprise the plurality of characters associated with the primary PIN;
receiving, by the authentication device, a dynamic PIN in a random sequence, comprising a combination of one or more secondary alpha-numeric characters and one or more colors, from the user; and
authenticating, by the authentication device, the user, by comparing the dynamic PIN with one or more secondary alpha-numeric characters and one or more colors associated with the primary PIN.

2. The method of claim 1, wherein the primary PIN is defined by the user.

3. The method of claim 1, further comprising providing an alpha-numeric keypad to the user to input the dynamic PIN, wherein each alpha-numeric character associated with the keypad is displayed with a color.

4. The method of claim 3, wherein the color associated with each alpha-numeric character changes after a predefined time period.

5. The method of claim 1, wherein the association between the plurality of primary alpha-numeric characters and the plurality of secondary alpha-numeric characters changes periodically.

6. The method of claim 1, wherein the color associated with each secondary alpha-numeric character changes periodically.

7. An authentication device for authenticating a user on an electronic device, comprising:
a processor; and
a memory storing instructions that, when executed by the processor, causes the processor to:
access a primary Personal Identification Number (PIN) associated with the user, wherein the primary PIN comprises at least one alpha-numeric character;
display a plurality of primary alpha-numeric characters associated with a plurality of secondary alpha-numeric characters, wherein each secondary alpha-numeric character is associated with a color, further wherein the plurality of primary alpha-numeric characters comprise the plurality of characters associated with the primary PIN;
receive a dynamic PIN in a random sequence, comprising a combination of one or more secondary alpha-numeric characters and one or more colors, from the user; and
authenticate the user, by comparing the dynamic PIN with one or more secondary alpha-numeric characters and one or more colors associated with the primary PIN.

8. The authentication device of claim 7, wherein the instructions further comprise instructions to provide an alpha-numeric keypad to the user to input the dynamic PIN, wherein each alpha-numeric character associated with the keypad is associated with a color.

9. The authentication device of claim 8, wherein the instructions include an instruction to change the color associated with each alpha-numeric character after a predefined time period.

10. The authentication device of claim 7, wherein the instructions further comprise an instruction to change the association between the plurality of primary alpha-numeric characters and the plurality of secondary alpha-numeric characters periodically.

11. The authentication device of claim 7, wherein the instructions further comprise an instruction to change the color associated with each secondary alpha-numeric character periodically.

12. A non-transitory computer-readable medium storing instructions for authenticating a user on an electronic device, wherein upon execution of the instructions by one or more processors, the processors perform operations comprising:
accessing, by an authentication device, a primary Personal Identification Number (PIN) associated with the user, wherein the primary PIN comprises at least one alpha-numeric character;
displaying, by the authentication device, a plurality of primary alpha-numeric characters associated with a plurality of secondary alpha-numeric characters, wherein each secondary alpha-numeric character is associated with a color, further wherein the plurality of primary alpha-numeric characters comprise the plurality of characters associated with the primary PIN;
receiving, by the authentication device, a dynamic PIN in a random sequence, comprising a combination of one or more secondary alpha-numeric characters and one or more colors, from the user; and
authenticating, by the authentication device, the user, by comparing the dynamic PIN with one or more secondary alpha-numeric characters and one or more colors associated with the primary PIN.
